(19) United States
(12) Patent Application Publication
(10) Pub. No.: US 2016/0316972 A1
(43) Pub. Date: Nov. 3, 2016

(54) Blending Appliance with Agitator with Stirring Blades

(71) Applicant: Sunbeam Products, Inc., Boca Raton, FL (US)

(72) Inventor: Jamal F. Hammad, Boynton Beach, FL (US)

(73) Assignee: Sunbeam Products, Inc., Boca Raton, FL (US)

(21) Appl. No.: 15/144,525

(22) Filed: May 2, 2016

Related U.S. Application Data
(60) Provisional application No. 62/155,890, filed on May 1, 2015.

(51) Int. Cl. A47J 43/07; B01F 15/00; A47J 43/046; A47J 43/08; B01F 7/00

(52) U.S. Cl. CPC A47J 43/0722; A47J 43/085; B01F 7/00425; B01F 7/00275; A47J 43/046; B01F 15/00538; B01F 2015/00597; B01F 2215/0014

(57) ABSTRACT

A blending appliance is provided including a motorized base, a blending container, and an agitator configuration fitted into an opening of the blending container and rotatably coupled to the motorized base when the blending container is mounted on the motorized base. The agitator configuration includes at least a first blade form performing a blending operation on ingredients at a lower end of the blending container and at least a second blade form extending vertically upward from the first blade form and performing a processing operation on the ingredients in the blending container above the first blade form. The at least second blade form includes a pair of opposing elongated spiral shaped Hades that spiral in a direction of rotation of the agitator configuration when the motorized base is energized and configured to stir ingredients and force ingredients down into the first blade form.

### CROSS-REFERENCE TO RELATED APPLICATION

The present application claims benefit of U.S. Provisional Patent Application No. 62/155,890 filed May 1, 2015, entitled “Blender Dancing Blades”.

### FIELD OF THE INVENTION

The invention relates to food preparation devices. More particularly, the invention relates to an improved blending appliance with an agitator assembly having both conventional blending blades and a blending implement for causing food contents to be stirred and forced down into the conventional blending blades.

### BACKGROUND OF THE INVENTION

Blending appliances used to blend beverages from solid and liquid ingredients are known. These blending appliances typically use agitators formed from blade sets that perform different functions. Known problems include cavitation and solidification of blending ingredients in areas of the blending jar remote from the agitator configuration typically disposed at the bottom of the blending jar.

### SUMMARY OF THE INVENTION

In an embodiment, there is provided a blending appliance including a motorized base, a blending container, and an agitator configuration fitted into an opening of the blending container and rotatably coupled to the motorized base when the blending container is mounted on the motorized base. The agitator configuration includes at least a first blade form performing a blending operation on ingredients at a lower end of the blending container and at least a second blade form extending vertically upward from the first blade form and performing a processing operation on the ingredients in the blending container above the first blade form. The at least second blade form includes a pair of opposing elongated spiral shaped blades that spiral in a direction of rotation of the agitator configuration when the motorized base is energized and configured to stir ingredients and force ingredients down into the first blade form.

In an embodiment, there is provided an agitator configuration including at least a first blade form performing a blending operation on ingredients at a lower end of a blending container and at least a second blade form extending vertically upward from the first blade form and performing a processing operation on the ingredients in the blending container above the first blade form. The at least second blade form includes a pair of opposing elongated spiral shaped blades that spiral in a direction of rotation of the agitator configuration when rotated and configured to stir ingredients and force ingredients down into the first blade form.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a blending appliance with a blending jar with an improved agitator blade configuration;

FIG. 2 is an exploded view of the blending jar of FIG. 1 with the improved agitator blade configuration;

FIG. 3 is a partially cutaway sectional view of the improved agitator blade configuration of FIG. 2;

FIG. 4 is an exploded view of the improved agitator blade configuration of FIG. 2; and

FIG. 5 is a top view of the improved agitator configuration of FIG. 2.

### DETAILED DESCRIPTION OF THE INVENTION

While the present invention may be susceptible to embodiment in different forms, there are shown in the drawings, and herein will be described in detail, embodiments with the understanding that the present description is to be considered an exemplification of the principles of the invention and is not intended to limit the invention to that as illustrated and described herein. Instead, it is envisioned that those skilled in the art may devise various modifications and equivalents without departing from the spirit and scope of the appended claims.

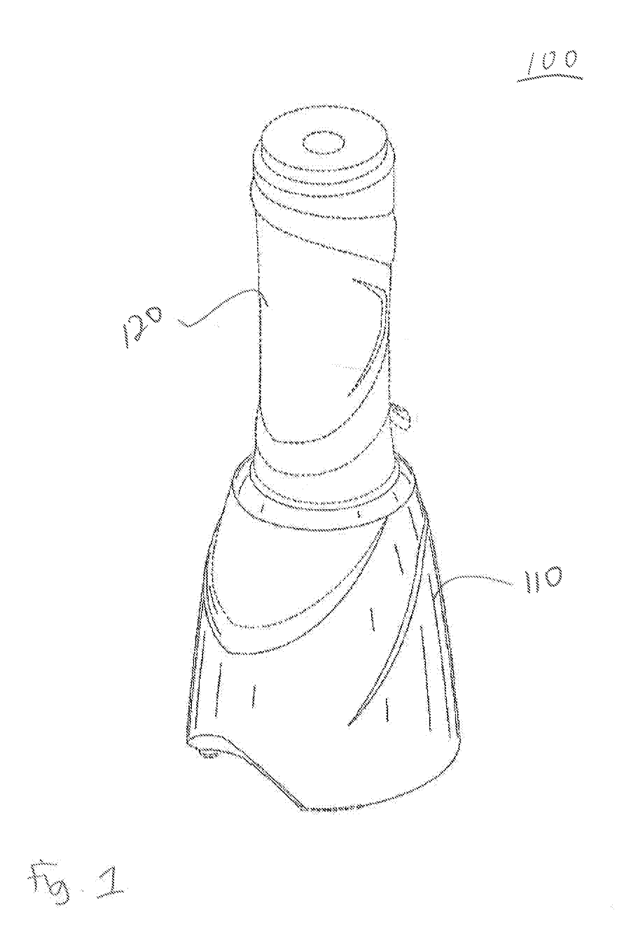

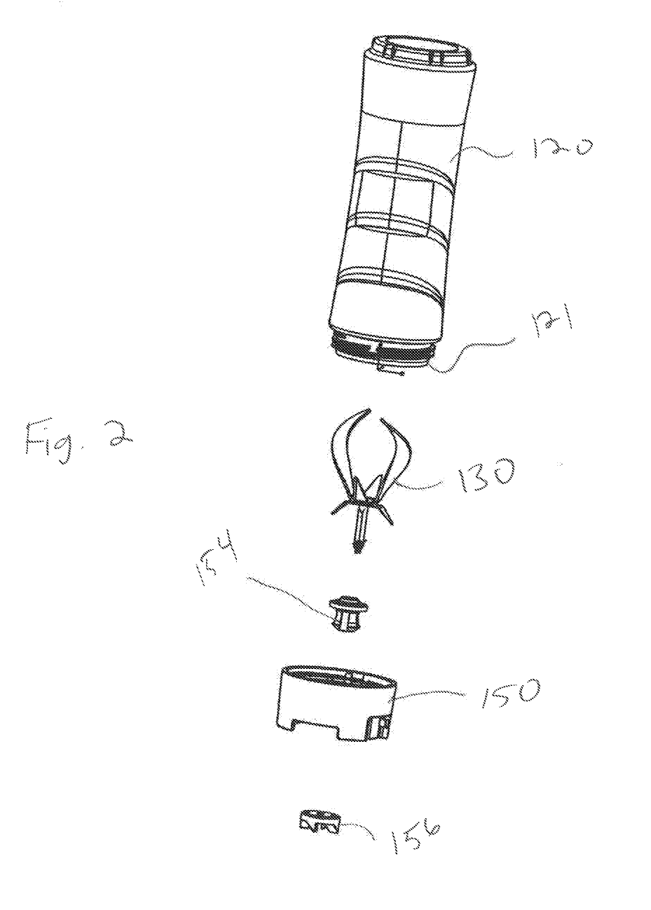

Referring now to FIGS. 1 and 2 of the drawings, in an embodiment there is illustrated a blending appliance 100. The blending appliance 100 includes a motorized base 110 and a blending jar 120. In use, the blending jar 120 fits into a recess (not shown) in the base 110. The base 110 includes an electrical motor (not shown) for providing rotary power to an agitator configuration 130 disposed within the blending jar 120. Electronic controls (not shown) in the base 110 control electrical power to the electrical motor (not shown) which in an embodiment may include one or more switches (not shown) for controlling the electrical motor (not shown) at various speeds including “off”, “low”, “medium” and “high”. In an alternate embodiment, the electronic controls (not shown) may include a microprocessor (not shown) with memory storing pre-programmed routines for controlling the electrical motor (not shown).

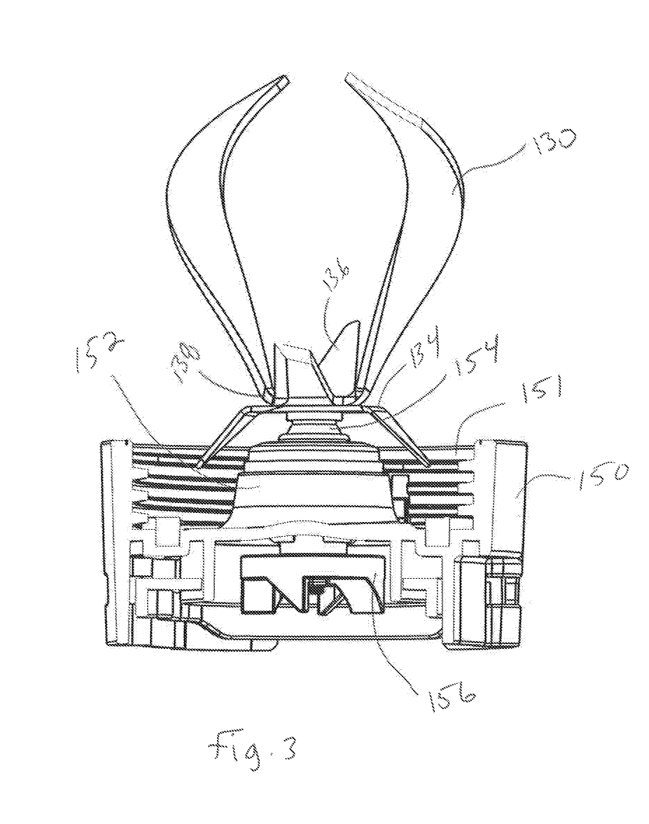

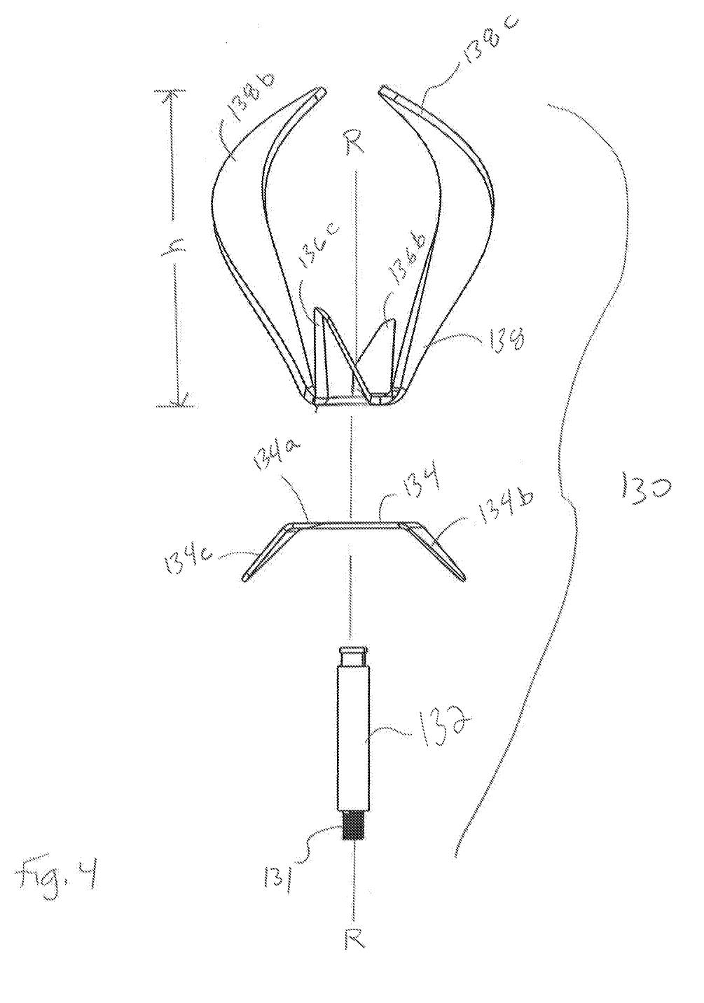

The agitator blade configuration 130 is inserted into an open end of the blending jar 120 and secured therein with an agitator nut 150 having internal threads 151 that engage complementary threads 121 on the bottom end of the blending container 120. The agitator configuration 130 includes a spindle 132 that fits into a bearing assembly 154 that further fits into a hub 152 (FIG. 3) formed in the agitator nut 150. The agitator configuration 130 is secured to the agitator nut 150 with a threaded coupling 156 that engages threads 133 (best seen in FIG. 4.) on the bottom end of the spindle 132 of the agitator configuration 130. The coupling 156 has projections (not shown) that engage complementary projections (not shown) on a rotary coupling (not shown) disposed in the recess (not shown) in the base 110. The rotary coupling (not shown) in the base 110 is rotated by the electric motor (not shown) when energized and engages the coupling 156 which further rotates the agitator configuration 130.

In use, ingredients are placed into the blending jar 120 prior to the agitator blade configuration 130 being inserted into an open end of the blending jar 120 and secured with the agitator nut 150. After blending, the agitator nut 150 and the agitator configuration 130 may be removed and the blended contents poured into another receptacle for further disposition. Alternately, a specially formed threaded drinking cap (not shown) with a drinking hole (not shown) may be threaded onto threads 121 of the blending jar 120. Blended contents may be drank directly from the blending jar 120 through the drinking hole (not shown) in the drinking cap (not shown).

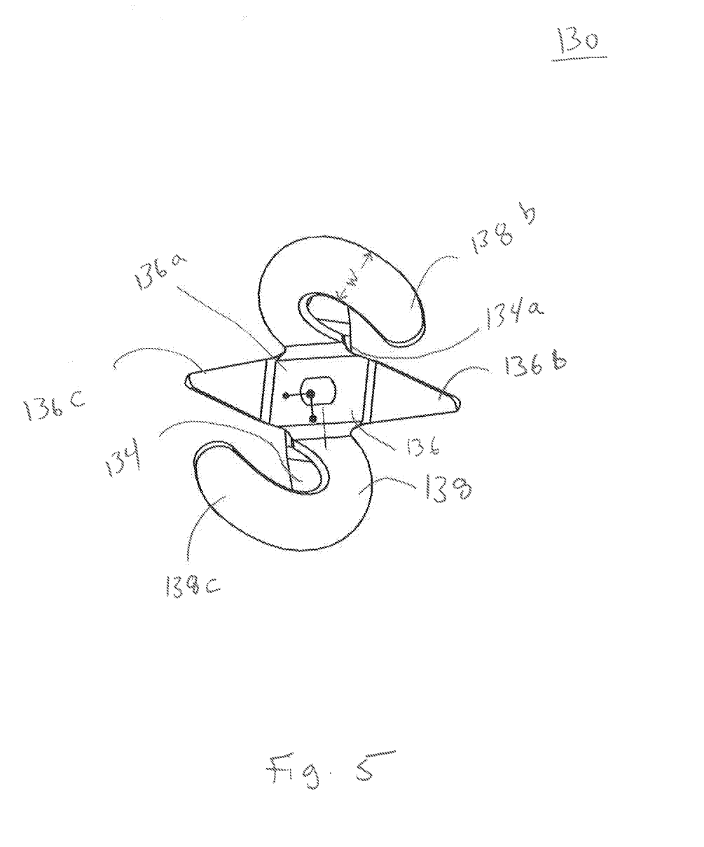

Referring now particularly to FIGS. 4 and 5, there is illustrated an embodiment of an improved agitator configuration 130. The agitator configuration 130 includes a blade stack mounted on a spindle 132. The blade stack includes a lower blade form 134 with opposing sharpened leading edges, a middle blade form 138 and an upper blade form 136 having opposing sharpened leading edges. The middle blade form 138 is integrally formed with the upper blade form 136. Alternately, the middle blade form 138 and the upper blade form 136 may be formed separately. The blade forms 134, 136 and 138 may be made of any durable material such as metal, steel, carbon, composites, or any combinations of such material which can be sharpened and withstand the high stresses and heats generated in this environment.

The lower blade form 134 and upper blade form 136 are preferably similar to a conventional blender blade design (one or more generally U-shaped blades). In particular, the lower blade form 134 includes a central, substantially flat base 134a that extends radially with respect to the rotational axis R-R of the agitator configuration 130. A first wing portion 134b extends at a first angle downward from the base 134a and an opposing second wing portion 134c extends at a second angle downward from an opposing end of the base 134a. While it is preferred that first and second wing portion's 134b and 134c respective angles are not equal so as to provide enhanced blending and processing, it should be noted that such angles may be identical. In this manner, solid ingredients are grinded and prevented from building up at the bottom of the jar 120 by the lower blade form 134. The leading edges of the first and second wing portion's 134b and 134c are sharpened facing the direction of rotation of the agitator configuration 130. In the example illustrated, the leading edges of the first and second wing portion's 134b and 134c are sharpened for a clockwise rotation of the agitator configuration 130. In an alternate embodiment, the opposite edges of the first and second wing portion's 134b and 134c may be sharpened for a counter-clockwise rotation of the agitator configuration 130.

As with the lower blade form 134, upper blade form 136 includes a central, substantially flat base 136a extending radially with respect to the rotational axis R-R of the agitator configuration 130. A first wing portion 136b extends at a first angle upward from the base 136a and a second wing portion 136c extends at a second angle upward from an opposing end of the base 136a. While it is preferred that first and second wing portion's 136b and 136c respective angles are not equal so as to provide enhanced blending and processing, it should be noted that such angles may be identical. The leading edges of the first and second wing portion's 136b and 136c are sharpened facing the direction of rotation of the agitator configuration 130. In the example illustrated, the leading edges of the first and second wing portion's 136b and 136c are sharpened for a clockwise rotation of the agitator configuration 130. In an alternate embodiment, the opposite edges of the first and second wing portion's 136b and 136c may be sharpened for a counter-clockwise rotation of the agitator configuration 130.

In an embodiment, there is sandwiched between the lower blade form 134 and the upper blade form 136 the middle blade form 138. The middle blade form 138 is comprised of the base 136a and opposing first 138b and second 138c elongated blades that curve or spiral as they extend upwardly into the interior of the blending jar 110. In the illustrated embodiment, the first 138b and second 138c spiral blades spiral clock-wise from the base 136a to their distal tips for a clockwise rotation of the agitator configuration 130. In another embodiment, the first 138b and second 138c spiral blades spiral counter clock-wise from the base 136a to their distal tips. It should be noted that the middle blade form 138 comprised of the first 138b and second 138c spiral blades may be added to any existing or future agitator blade configuration. The first 138b and second 138c spiral blades are formed from suitable material formed into a flat bar shape and spiral or curve in the direction of rotation in a range from greater than zero degrees 0° to less than ninety-degrees 90°. The distal tips of the first 138b and second 138c spiral blades may be rounded but this is not meant to be limiting. The first 138b and second 138c spiral blades prevent cavitation of solid or frozen ingredients that will solidify during blending and create a cavity or air pocket around the agitator blade configuration 130. The first 138b and second 138c spiral blades create turbulence preventing solidification of the solid or frozen ingredients and a suction that forces the ingredients into the upper and lower blade forms 136, 134 below. The width (w) and height (h) are dependent upon the diameter and height of the blending jar 120 and optimized to stir blended contents and force ingredients down into the blade forms 136 and 134, particularly at low blending speeds required for blending protein drinks and the like. In a non-limiting example, the height (h) of the first 138b and second 138c spiral blades may be in the range of thirty millimeters (35 mm) to seventy millimeters (70 mm). In a non-limiting example, the width (w) of the first 138b and second 138c spiral blades may be in the range of five millimeters (5 mm) to twenty millimeters (20 mm).

In an embodiment, the first and second wing portion's 134b and 134c are arranged ninety-degrees (90°) to the first and second wing portion's 136b and 136c. The first 138b and second 138c spiral blades are arranged ninety-degrees (90°) to the first and second wing portion's 136b and 136c.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A blending appliance, comprising:
a motorized base;
a blending container; and
an agitator configuration fitted into an opening of the blending container and rotatably coupled to the motorized base when the blending container is mounted on the motorized base, the agitator configuration including:
at least a first blade form performing a blending operation on ingredients at a lower end of the blending container;
at least a second blade form extending vertically upward from the first blade form and performing a processing operation on the ingredients in the blending container above the first blade form, the at least second blade form including:
a pair of opposing elongated spiral shaped blades that spiral in a direction of rotation of the agitator configuration when the motorized base is energized and configured to stir ingredients and three ingredients down into the first blade form.

2. The blending appliance of claim 1, wherein the first blade form includes opposing wing portions angled upward and having sharpened leading edges in the direction of rotation of the agitator configuration configured to blend ingredients above the first blade form.

3. The blending appliance of claim 1, further including a third blade form including opposing wing portions angled downward and having sharpened leading edges in the direction of rotation of the agitator configuration configured to grind and dislodge blending ingredients at a bottom of the blending container.

4. The blending appliance of claim 1, wherein each spiral shaped blade has a width in the range of five millimeters to twenty millimeters.

5. The blending appliance of claim 1, wherein each spiral shaped blade has a height in the range of thirty-five millimeters to seventy millimeters.

6. An agitator configuration, comprising:
at least a first blade form performing a blending operation on ingredients at a lower end of a blending container;
at least a second blade form extending vertically upward from the first blade form and performing a processing operation on the ingredients in the blending container above the first blade form, the at least second blade form including:
a pair of opposing elongated spiral shaped blades that spiral in a direction of rotation of the agitator configuration when rotated and configured to stir ingredients and force ingredients down into the first blade form.

7. The agitator configuration of claim 6, wherein the first blade form includes opposing wing portions angled upward and having sharpened leading edges in the direction of rotation of the agitator configuration configured to blend ingredients above the first blade form.

8. The agitator configuration of claim 6, further including a third blade form including opposing wing portions angled downward and having sharpened leading edges in the direction of rotation of the agitator configuration configured to grind and dislodge blending ingredients at a bottom of the blending container.

9. The agitator configuration of claim 6, wherein each spiral shaped blade has a width in the range of five millimeters to twenty millimeters.

10. The agitator configuration of claim 6, wherein each spiral shaped blade has a height in the range of thirty-five millimeters to seventy millimeters.
